(19) United States
(12) Patent Application Publication
(10) Pub. No.: US 2018/0120026 A1
(43) Pub. Date: May 3, 2018

(54) METHODS FOR MEASURING PRESSURE IN FREEZE DRYING SYSTEMS

(71) Applicant: Steven Finley, Wayne, NJ (US)

(72) Inventor: Steven Finley, Wayne, NJ (US)

(21) Appl. No.: 15/340,522

(22) Filed: Nov. 1, 2016

(51) Int. Cl. F26B 5/06; G01L 11/00

(52) U.S. Cl. CPC F26B 5/06; G01L 11/00

(57) ABSTRACT

An improved method for determining pressure in a lyophilisation system containing a lyophilisation chamber and a condenser chamber wherein a freeze drying operation is being performed is provided for. The improved method uses a temperature measuring device such as a thermocouple or a temperature resistance device to measure temperature and from this measurement the pressure of the components in the lyophilisation chamber can be calculated using a predetermined relationship between temperature and pressure.

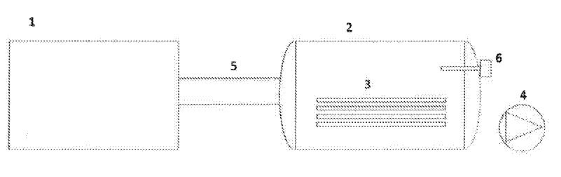

### BACKGROUND OF THE INVENTION

In lyophilisation, vials containing an aqueous mixture are frozen, and then subjected to vacuum to drive sublimation of frozen and bound water from the vials. Cooling of the vials is typically accomplished by cooling the shelves or trays on which the vials are resting within the lyophilisation chamber. The shelves are typically cooled by circulating a heat transfer fluid, such as SYLTHERM® heat transfer fluid from Dow Corning, through them using either mechanical refrigeration or indirect cryogenic cooling which typically uses liquid nitrogen as the cryogen.

Other systems use cool shelves and a condenser whereby the heat transfer fluid is cooled with liquid nitrogen and the condenser is cooled with cold nitrogen gas. In this system the cooling capacity is distributed two-thirds to the shelves and one-third to the condenser. The temperature of the condenser is critical in managing the vacuum level in the condenser. The lower the water's vapor pressure in the system, the lower the vacuum will be therefore the higher the rate of sublimation in the lyophilisation unit.

Measurement of the vacuum to meet the demands of a highly regulated process can be difficult and expensive. First transmitters such as Pirani gauges with the level of accuracy suitable for this demanding process are costly, sensitive to the gas composition and challenging to sterilize.

The present invention provides an improved process to these more costly and/or difficult to maintain and sterilize pressure sensing devices.

### SUMMARY OF THE INVENTION

In a first embodiment of the invention there is disclosed an improved method for determining pressure in a lyophilisation system wherein a freeze drying operation is being performed, the improvement comprising measuring temperature in the lyophilisation system and calculating pressure of the lyophilisation system therefrom using a predetermined relationship between temperature and pressure.

In a second embodiment of the invention there is disclosed an improved freeze drying method in a lyophilisation system, the improvement comprising measuring temperature in the lyophilisation system and calculating pressure of the lyophilisation system therefrom.

The lyophilisation system will comprise a lyophilisation chamber and a condenser chamber. The condenser chamber will contain a condenser coil and be in fluid communication with a vacuum pump for assistance in lowering the pressure of the lyophilisation system.

The temperature is measured with a device selected from the group consisting of a thermocouple and a resistance temperature device.

While each lyophilisation system will be different from operation to operation, a basic relationship between the temperature of the lyophilisation system and pressure of the lyophilisation system can be established based on known principles. For example, these known principles include Boyle's Law, Charles' Law, Gay Lussac's Law, Combined Gas Law and the Ideal Gas Law. Given the importance of operating the lyophilisation system at a proper desired pressure, this relationship will be known by the operator of the lyophilisation. Accordingly, the predetermination of pressure from temperature or temperature from pressure will be known to the operator of the lyophilisation system. Therefore the operator of the present invention will measure temperature and calculate the pressure of the lyophilisation system by using a predetermined relationship between temperature and pressure.

Water, nitrogen and air are present in the lyophilisation system.

The freeze drying or lyophilisation operation is typically performed in a freeze drying chamber where one or more vials containing an aqueous based product are processed. The freeze drying operation will typically be performed in a sterile environment in which water-based solutions in vials are is fed into the chamber. The temperature of the chamber is then reduced by a variety of means such as by passing a refrigerant through the cold plates upon which the vials are placed. Typically these temperatures can be as low as −100° C.

Once the temperature of the freeze drying chamber is reduced, its pressure is also reduced down to pressures below 0.01 mBar absolute.

The gas that is present in the freeze drying chamber is typically air or nitrogen.

During the initial phase of freeze drying, water in the vials is frozen by cooling the shelves as described above. In some cases, the temperature at which the contents of the vials freeze is controlled through the use of controlled nucleation employing either nucleation by sterile seed ice crystals or “ice fog” U.S. Pat. No. 8,549,768 or through rapid depressurization. In either case, the contents of the vials are frozen at the same; or very close to the same temperature; typically minus 5 degrees C.+/−1 degree C.

Following freezing, the next phase of freeze drying is sublimation. During sublimation, the water ice in the vials is converted directly to the vapor phase. For sublimation to occur and to be effective, the absolute pressure in the lyophilisation chamber must be very low; in the range of 0.01 mBar absolute. The low pressure in the chamber provides a driving force to cause water to vaporize and to be transferred from the vials. The vacuum in the lyophilisation is regulated using a combination of a vacuum pump and a low-temperature condenser. The condenser provides primary control of the vacuum and its effectiveness is directly correlated to the temperature of the surface of the condenser coils. Water vapor from the vials is frozen onto the surface of the condenser's coils in a process known as deposition whereby water vapor is converted directly to the solid state without condensing to the liquid state.

It is well known that the vapor pressure of compounds is a function of the temperature of that compound. The lower the temperature, the lower the vapor pressure of that compound. The vapor pressure of a compound can be expressed as the partial pressure of that compound within the boundaries of a defined closed system containing a mixture of gases and vapors.

In a simple case, a lyophilisation system can be defined as the lyophilisation chamber containing the shelves, the vials and the volume defined by the walls of the chamber; along with associated instruments and other necessary equipment. The condenser consists of a vessel with an internal volume defined by the dimensions of the vessel, a heat-exchange coil and necessary instruments and devices. The condenser system is in communication with the lyophilisation chamber and a vacuum pump.

According to Dalton's Law, the total pressure in the system can generally be defined as the sum of partial pressures within the chamber.

Pₜₒₜₐₗ=Σᵢ₌₀ⁿPi

where P₁, P₂ . . . Pₙ represent the partial pressures of each component and

Pᵢ=Pₜₒₜₐₗyᵢ

where yᵢ is the mole fraction of the ith component in the total mixture of n components.

For a lyophilisation system, the total pressure is generally a combination of the partial pressures of nitrogen, water vapor and to a lesser degree, other gases like oxygen. The vacuum pump removes a significant mass of the gases reducing the total pressure in the chambers, then the condenser further lowers the total pressure through deposition of water vapor; reducing the partial pressure of water vapor as well as the total pressure of the chamber.

The above equation is useful in calculating the average pressures; however there is a gradient of partial and total pressures; beginning with the highest pressures at the vials and the lowest at the surface of the condenser coils. For the water vapor, this difference in pressure drives water vapors from the vials to the condensers as the lyophilisation cycle progresses.

In this invention, the temperature of the gas in the freeze drying chamber is measured with a device selected from the group consisting of a thermocouple and a resistance temperature device (RTD). These devices are capable of working in the freeze drying chamber across a range of cryogenic temperatures and can also work in sterile environments typically necessary for freeze drying operations.

Once the temperature is measured, the vapor pressure of the water or pressure in the chamber can be calculated by a device capable of performing calculations such as a programmable logic controller (PLC). These devices will input the temperature data and perform a calculation to derive the vapor pressure of the water or pressure in the chamber and display this result to the operator.

For validation of the Temperature-Pressure relationship, measurements can be taken using a temperature instrument along with a pressure instrument; for example, a Pirani gauge. Through detailed measurement, a relationship can be established between the temperature and the measured pressure. This relationship can be used to develop an algorithm to calculate the absolute pressure as a function of the chamber's temperature.

### BRIEF DESCRIPTION OF THE DRAWINGS

The FIGURE is a schematic of a lyophilisation system showing the relationship between the lyophilisation chamber and the condenser chamber.

### DETAILED DESCRIPTION OF THE INVENTION

The FIGURE shows a schematic of a lyophilisation system where a lyophilisation chamber 1 is connected via a conduit 5 to a condenser chamber. The lyophilisation chamber 1 is where the freeze drying operation is performed. The lyophilisation chamber 1 will contain the shelves and the vials to be processed. Typically the lyophilisation chamber 1 will be a sterile environment.

The freeze drying operation will be performed at temperatures as low as −100° C. The pressure of the chamber is also reduced to below 0.01 mBar absolute. After the contents of the vials are frozen, the sublimation step occurs in the lyophilisation chamber 1. The water ice in the vials is converted into vapor in part due to the low pressure in the lyophilisation chamber 1. This low pressure is provided by the condenser chamber 2 operation whereby condenser coil 3 and a vacuum pump 4 operate to provide the vacuum to the lyophilisation chamber 1. The water vapor sublimating from the vials will condense on the condenser coil 3 and become frozen to its surface.

The temperature of the condenser chamber 2 will be measured by an instrument 6 which is typically a thermocouple or a resistance temperature device (RTD). Since there is a correlation between temperature and vapor pressure of compounds, the use of the instrument 6 will assist in determining the pressure of the gases present in the lyophilisation system.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. An improved method for determining pressure in a lyophilisation system wherein a freeze drying operation is being performed, the improvement comprising measuring temperature in the lyophilisation system and calculating pressure of the lyophilisation system therefrom using a predetermined relationship between temperature and pressure.

2. The method as claimed in claim 1 wherein the lyophilisation system comprises a lyophilisation chamber and a condenser chamber.

3. The method as claimed in claim 1 wherein the temperature is measured with a device selected from the group consisting of a thermocouple and a resistance temperature device.

4. The method as claimed in claim 1 wherein the pressure is calculated from the temperature according to the formula:

5. The method as claimed in claim 1 wherein water, nitrogen and air are present in the lyophilisation system.

6. The method as claimed in claim 2 wherein the condenser chamber contains a condenser coil.

7. The method as claimed in claim 2 wherein the condenser chamber is in fluid communication with a vacuum pump.

8. An improved freeze drying method in a lyophilisation system, the improvement comprising measuring temperature in the lyophilisation system and calculating pressure of the lyophilisation system therefrom.

9. The method as claimed in claim 8 wherein the lyophilisation system comprises a lyophilisation chamber and a condenser chamber.

10. The method as claimed in claim 8 wherein the temperature is measured with a device selected from the group consisting of a thermocouple and a resistance temperature device.

11. The method as claimed in claim 8 wherein the pressure is calculated from the temperature according to the formula:

12. The method as claimed in claim 8 wherein water, nitrogen and air are present in the lyophilisation system.

13. The method as claimed in claim 9 wherein the condenser chamber contains a condenser coil.

14. The method as claimed in claim 9 wherein the condenser chamber is in fluid communication with a vacuum pump.
